(19) United States
(12) Patent Application Publication
(10) Pub. No.: US 2013/0191437 A1
(43) Pub. Date: Jul. 25, 2013

(54) DISTRIBUTED PROCESSING SYSTEM AND METHOD OF NODE DISTRIBUTION IN DISTRIBUTED PROCESSING SYSTEM

(71) Applicant: Akihiro Itoh, Kawasaki (JP)

(72) Inventor: Akihiro Itoh, Kawasaki (JP)

(73) Assignee: HITACHI, LTD., Tokyo (JP)

(21) Appl. No.: 13/876,900

(22) PCT Filed: Oct. 1, 2010
(86) PCT No.: PCT/JP2010/067208

§ 371 Date: Mar. 29, 2013

(51) Int. Cl. G06F 15/173

(52) U.S. Cl. CPC G06F 15/17375
USPC 709/201

(57) ABSTRACT

It is provided a distributed processing system comprising a two or more dimensional grid network, on which a virtual ring of a consistent hash is created, for coupling a plurality of nodes to which hash values are assigned, the plurality of nodes including at least a computational resource, and the nodes arranged at positions adjacent on the virtual ring being arranged at positions capable of communication without via other nodes in the grid network.

### BACKGROUND OF THE INVENTION

The present invention relates to a distributed processing system in a grid network and particularly to an implementation method of consistent hashing of a distributed database in a grid network.

Consistent hashing is known as a distributed database implementation method (see Consistent Hashing and Random Trees: Distributed Caching Protocols for Relieving Hot Spots on the World Wide Web, David Karger et al.) According to this literature, data is stored in the following procedure.

1. A virtual ring in which possible hash values are linked in a ring is supposed.
2. Hash values are assigned to computers capable of mutual communication in a network and arranged on the virtual ring.
3. Each computer serves as a primary node for a key having a hash value between a hash value of one previous computer and a hash value of its own.
4. Two successive computers after the primary node serve as backup nodes.
5. The primary node and the backup nodes hold data.

For example, in the case where a hash value of a key value “A” exists between hash values of computers N2 and N3 as illustrated in FIG. 25, the computer N3 serves as a primary node and computers N4, N5 serve as backup nodes. Thus, the key value “A” is stored in these computers N3, N4 and N5. Since values are normally managed in relation to key values in a database, values are stored in the computers in which the key value is stored.

Conventionally, among many parallel databases, a central server manages data storage computers in an integrated manner and a client first transfers data to the central server in storing the data. This has presented a problem that the central server is highly loaded and it is difficult to exhibit scalability. In this consistent hashing method, a client possesses a list of computers and hash values held by each computer and can uniquely determine the computer for storing a key value. Thus, the client can directly access the computer in which data is stored. Thus, a database is used as a database with high scalability.

Further, this consistent hashing method has an advantage of less copying at the time of adding/deleting a computer. As illustrated in FIG. 26, in the case of adding a new computer N6, the primary node of the key value “A” is the computer N6 and the backup nodes are the computers N3 and N4. Thus, a configurational change is completed in the case where the data is copied into the computer N6 and deleted from the computer N5. When a computer is added in this way, the configuration can be changed by partial update.

In the case of constructing the distributed system as described above, a network for connecting the computers needs to be constructed.

Conventionally, a tree network as illustrated in FIG. 27 is commonly used.

FIG. 27 illustrates an example in which a tree network is constructed by network switches SW1 to SW4 and computers N1 to N9 are connected to these. In the tree network, it is a problem that loads are concentrated on upper-level network switches and a top-level network switch becomes a single point of failure. In view of this, a network topology for connecting computers in a grid arrangement is disclosed in JP H7-200508 and JP 2008-165531 A. A configuration for connecting nodes by a cross bar switch is adopted in JP H7-200508 and a configuration for directly connecting nodes to form a multi-dimensional torus structure is adopted in JP 2008-165531 A.

### SUMMARY OF THE INVENTION

In the case of implementing consistent hashing in a tree network, two configuration methods illustrated in patterns 1, 2 of FIG. 27 are thought as a configuration method of a virtual ring. Numbers illustrated as the patterns 1, 2 in FIG. 27 represent a sequence of nodes on the virtual ring. The pattern 1 is a configuration method for arranging nodes adjacent on the virtual ring at close positions network-wise. In this method, a network load in copying data between a primary node and a backup node can be reduced, but fault tolerance becomes lower since the nodes in which the data is to be copied are arranged under the same network switch.

The pattern 2 is a configuration method for arranging nodes adjacent on the virtual ring at distant positions on the network. In this method, fault tolerance can be enhanced, but a network load of upper-level switches in copying data between a primary node and a backup node become higher. As just described, the network load and the fault tolerance are in a tradeoff relationship in the case of implementing consistent hashing in the tree network and not compatible with each other.

In general, a grid network can balance fault tolerance and network load distribution, but application-side ingenuity is necessary to utilize a network expanding in a plurality of directions in a well-balanced manner and realize load distribution. Also in the case of implementing consistent hashing, loads are concentrated on a specific network switch unless a virtual ring is appropriately configured.

The representative one of inventions disclosed in this application is outlined as follows. There is provided a distributed processing system comprising a two or more dimensional grid network, on which a virtual ring of a consistent hash is created, for coupling a plurality of nodes to which hash values are assigned, the plurality of nodes including at least a computational resource, and the nodes arranged at positions adjacent on the virtual ring being arranged at positions capable of communication without via other nodes in the grid network.

According to a representative embodiment of the present invention, network load distribution and fault tolerance can be balanced in implementing consistent hashing on a grid network.

### BRIEF DESCRIPTION OF THE DRAWINGS

FIG. 1 is a configuration diagram illustrating a computer system (distributed database system) according to an embodiment of the present invention.

FIG. 2 is a configuration diagram illustrating a computer and a router according to the embodiment of the present invention.

FIG. 3 is an explanatory diagram illustrating a rule for arranging a representative node on a virtual ring according to the embodiment of the present invention.

FIG. 4 is an explanatory diagram illustrating an example for adding a non-representative node to the distributed database system according to the embodiment of the present invention.

FIG. 5 is an explanatory diagram illustrating an example for adding a non-representative node to the distributed database system according to the embodiment of the present invention.

FIG. 6 is a configuration diagram illustrating software installed in the router according to the embodiment of the present invention.

FIG. 7 is a configuration diagram illustrating software installed in a master computer according to the embodiment of the present invention.

FIG. 8 is a configuration diagram illustrating software installed in a DB computer

FIG. 9 is an explanatory diagram illustrating an example of a load notification message according to the embodiment of the present invention.

FIG. 10A is an explanatory diagram illustrating a router load management table according to the embodiment of the present invention.

FIG. 10B is an explanatory diagram illustrating a router load monitoring history table according to the embodiment of the present invention.

FIG. 11A is an explanatory diagram illustrating a switch load management table according to the embodiment of the present invention.

FIG. 11B is an explanatory diagram illustrating a switch load monitoring history table according to the embodiment of the present invention.

FIG. 12 is an explanatory diagram illustrating a router management table according to the embodiment of the present invention.

FIG. 13 is an explanatory diagram illustrating a node management table according to the embodiment of the present invention.

FIG. 14 is an explanatory diagram illustrating a switch setting table according to the embodiment of the present invention.

FIG. 15 is an explanatory diagram illustrating a client management table according to the embodiment of the present invention.

FIG. 16 is a flowchart illustrating processing for updating a router load according to the embodiment of the present invention.

FIG. 17 is a flowchart illustrating processing for adding the non-representative node according to the embodiment of the present invention.

FIG. 18 is a flowchart illustrating processing for changing configuration upon changing a grid size according to the embodiment of the present invention.

FIG. 19 is a configuration diagram illustrating a computer system (distributed database system) according to a first modified example of the embodiment of the present invention.

FIG. 20 is a configuration diagram illustrating a computer system (distributed database system) according to a second modified example of the embodiment of the present invention.

FIG. 21 is a configuration diagram illustrating a computer system (distributed database system) according to a third modified example of the embodiment of the present invention.

FIGS. 22A to 22D are explanatory diagrams illustrating examples of an arrangement of the representative node on a three-dimensional grid according to the embodiment of the present invention.

FIG. 23 is an explanatory diagram illustrating a method for arranging a representative node on the three-dimensional grid according to the embodiment of the present invention.

FIGS. 24A and 24B are explanatory diagrams illustrating methods for arranging a representative node on the three-dimensional grid according to the embodiment of the present invention.

FIG. 25 is an explanatory diagram illustrating a concept of the consistent hash.

FIG. 26 is an explanatory diagram illustrating a concept of adding a node in the consistent hash.

FIG. 27 is a configuration diagram illustrating a conventional tree network.

### DETAILED DESCRIPTION OF THE PREFERRED EMBODIMENTS

First, a summary of an embodiment of the present invention is described.

In the present embodiment, in creating a virtual ring of a consistent hash on a grid network having a number of dimensions equal to or greater than two dimensions, nodes adjacent on the virtual ring are arranged to be adjacent on the grid network.

The grid network is so configured that all network switches are passed the same number of times when nodes having (number of dimensions—1) matching coordinates are connected by the network switches and the grid network is followed a shortest path to go around nodes configuring a virtual ring along the virtual ring.

Further, in the present embodiment, a primary node and backup nodes are arranged at positions adjacent on the virtual ring and at different coordinate positions of the grid network.

Further, in the present embodiment, a router is arranged on each grid point of the grid network and computers configuring the virtual ring are connected to each router.

Further, in the present embodiment, the routers only one of coordinate elements of which indicating a position on the grid network does not match (i.e. (number of dimensions—1) coordinates match) are torus-connected concerning a connection method of the routers arranged at the grid points to which network segments are respectively connected.

Further, in the present embodiment, when the primary node and the backup nodes are arranged at the positions adjacent on the virtual ring and a client writes data on the primary node and the backup nodes, the data is written in a distributed database by transmitting the data to a node located in the middle on the virtual ring and transferring the data from the node having received the data from the client to other nodes.

Furthermore, in the present embodiment, when the primary node and the backup nodes are arranged at the positions adjacent on the virtual ring and a client writes data on the primary node and the backup nodes, the data is written in the distributed database by transmitting the data to a node having a shortest network distance from the client and transferring the data from the node having received the data from the client to other nodes.

Next, the present embodiment is described with reference to the drawings.

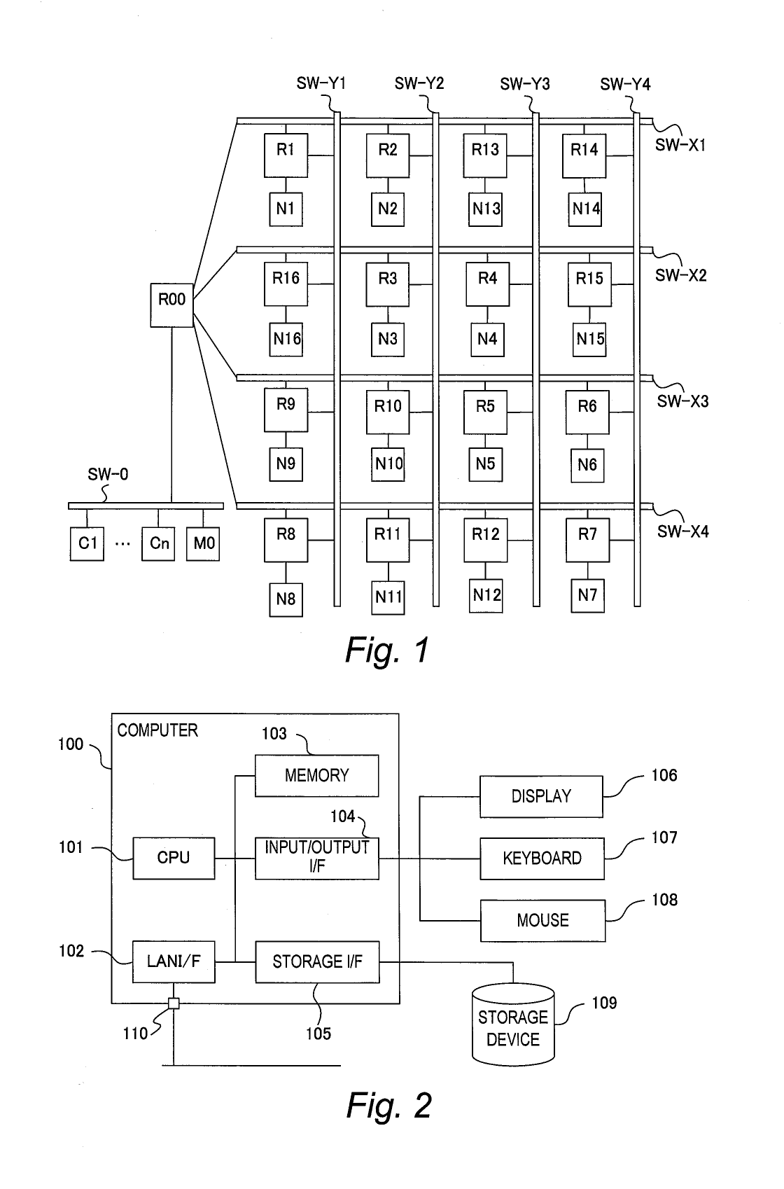

FIG. 1 is a configuration diagram illustrating a computer system according to the embodiment of the present invention.

The computer system (distributed database system) of the present embodiment includes routers R1 to R16 arranged in a grid, network switches SW-X1 to SW-X4, SW-Y1 to SW-Y4 connecting each router, DB computers N1 to N16 configuring a distributed database.

The routers are connected to each other by the network switches SW-X1 to SW-X4 extending in an X direction and the network switches SW-Y1 to SW-Y4 extending in a Y direction. The DB computers N1 to N16 are connected to the respective routers.

Accordingly, each router is connected to three types of network segments, i.e. an inter-router network segment to which the X-direction switch SW-X1 to SW-X4 is connected, an inter-router network segment to which the Y-direction switch SW-Y1 to SW-Y4 is connected and a computer network segment to which the DB computer N1 to N16 is connected. It should be noted that a plurality of computers may be connected to the computer network segment.

Client computers C1 to Cn utilizing this distributed database system are connected to a router R00 via a network switch SW-0. The router R00 is further connected to the network switches SW-X1 to SW-X4. For example, when accessing the computer N7, the client computer C1 accesses the computer N7 via the routers R00 and R7.

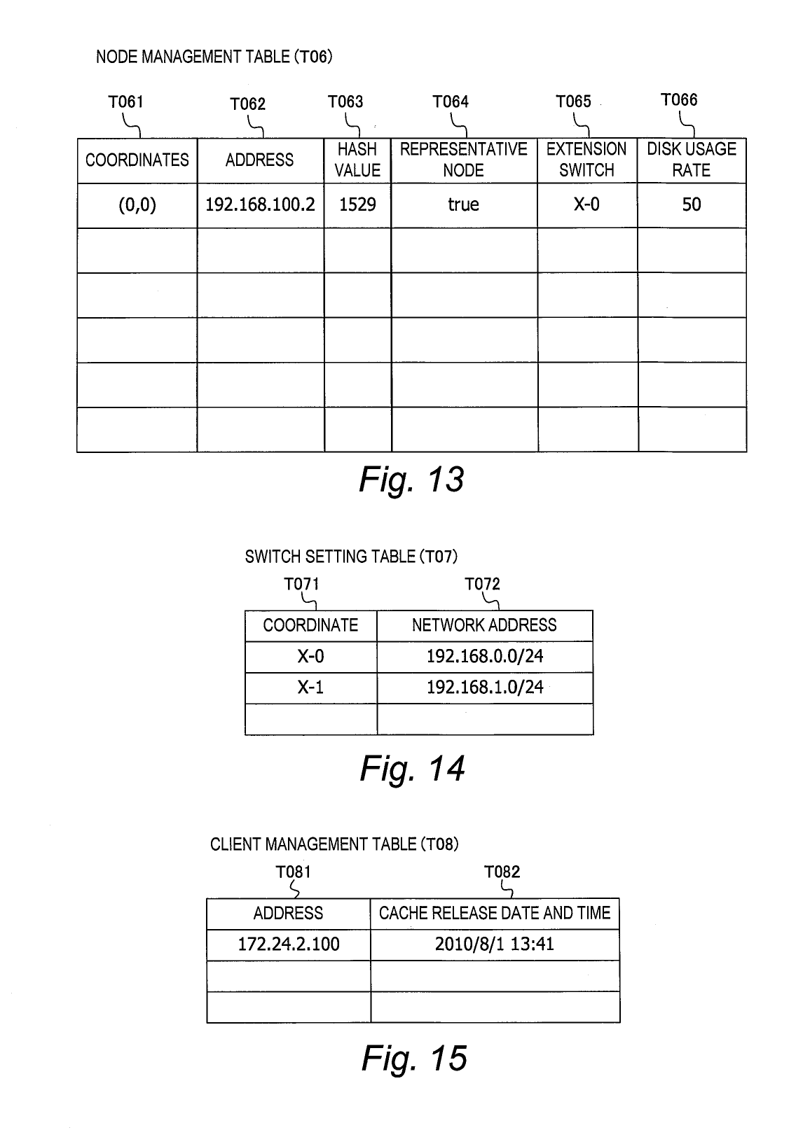

A master computer M0 is connected to the network switch SW-0. The master computer manages a correspondence relationship of coordinates, network addresses and hash values of the DB computers N1 to N16 on the network as a node management table T06 (FIG. 13). The client computers C1 to Cn obtain the node management table T06 from the master computer M0 at the time of the first access and changing the configuration of the system and determine the DB computer to be accessed based on this table. Since the DB computer in which a key value should be saved can be uniquely determined from the key value in the case where the node management table T06 is available, the client computers C1 to Cn and the master computer need not communicate at the time of the second and subsequent accesses.

In such a grid network, a routing table appropriate for the routers R1 to R16 and the router R00 need to be set. The routing table can be automatically set in each router by utilizing a routing protocol such as OSPF (Open Shortest Path First). However, it is necessary to set information on an address and network segments of the router in each router.

Although the client computers C1 to Cn and the master computer M0 are connected to the grid network via the router R00 in the computer system illustrated in FIG. 1, the client computers C1 to Cn and the master computer M0 may be connected to the computer segments of the routers R1 to R16 configuring the grid network. Further, the DB computers N1 to N16 may double as client computers. Further, although a grid size is 4×4 in the computer system illustrated in FIG. 1, the present invention is not limited to this and also applicable to other sizes.

The routers R1 to R16, R00 and the computers N1 to N16, C1 to Cn are computers having an internal configuration of a general architecture as illustrated in FIG. 2.

In a computer 100, a CPU 101, a LAN interface 102, a memory 103, an input/output interface 104 and a storage interface 105 are connected to each other by an internal bus. The LAN interface 102 is connected to an external network via a LAN port 110. Input/output devices such as a display 108, a keyboard 107 and a mouse 108 are connected to the input/output interface 104. The storage interface 105 is connected to a storage device 109 such as a magnetic disk drive.

A basic configuration of the computer is as described above. However, in the router, a plurality of (three or more in the present embodiment) LAN ports 110 are provided and an impact-resistant memory such as a flash memory is used as the storage device 109. Further, in the router, an accelerator chip dedicated for routing may be connected to the internal bus to improve communication performance in some cases.

Further, the display, the keyboard 107 and the mouse 108 may not be connected to the DB computer N1 to N16.

Next, a configuration method of a virtual ring in consistent hashing is described. Signs of the computers illustrated in FIG. 1 represent a sequence of configuring the virtual ring. Specifically, the virtual ring is gone around by starting from N1 and following the computers in the order of N2, N3, . . . , N16 and N1. This configuration has the following features.

Feature 1: The computers adjacent on the virtual ring are also adjacent on a physical network.
Feature 2: In the case where the computers adjacent on the virtual ring are successively followed, the network switches configuring the grid network are passed the same number of times. In an example illustrated in FIG. 1, each of the network switches SW-X1 to SW-X4, SW-Y1 to SW-Y4 is passed twice.
Feature 3: The computers adjacent on the virtual ring are connected to different routers.

Since data is copied between a primary node and backup nodes in consistent hashing, a data transfer amount between the computers adjacent on the virtual ring increases. Accordingly, it is efficient if the virtual ring is so configured as to shorten network distances between the computers adjacent on the virtual ring. This can be realized by the feature 1 described above. Further, to distribute a network load between the computers adjacent on the virtual ring, communication between the adjacent computers may be distributed utilizing a plurality of network switches. This can be realized by the feature 2 described above. Further, in the case where a specific router breaks down, data on the computers connected to other routers can be used by the feature 3. Thus, fault tolerance can be enhanced. Network load distribution and fault tolerance can be balanced by the above features 1 to 3.

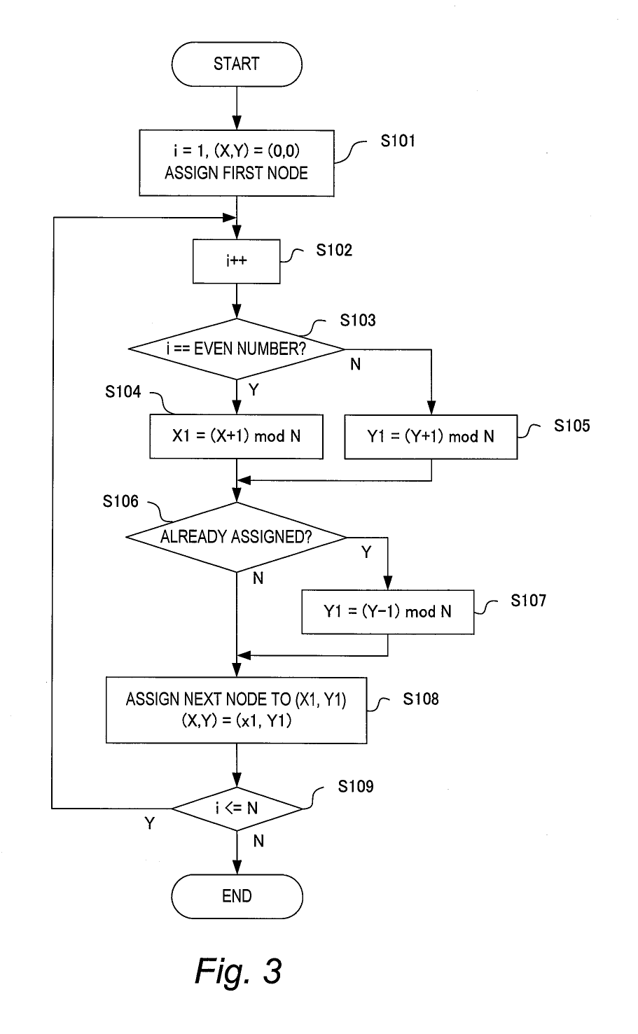

This virtual ring can be created by a process illustrated in FIG. 3. A specific creation method is described below. Although this process is performed by the master computer M0, it may be performed by another computer.

First, a computer number i is initialized to 1 and node coordinates (X, Y) are initialized to (0, 0), whereby the first computer N1 is assigned to the coordinates (0, 0) (S101). Specifically, the upper-left position of FIG. 1 is the coordinates (X, Y)=(0, 0) and the position moves rightward as X becomes larger while moving downward as Y becomes larger.

Subsequently, the computer number i is incremented to determine the computer number of the computer for which the position is determined next (S102). In the case where the determined computer number is an even number, it is determined whether or not the computer can be assigned to one forward position in the X direction (S103, S104, S106). If it is possible to assign the computer to this position, the next computer is assigned to the coordinates of this position (S108).

In the case where the computer number is an odd number after the computer number i is incremented in Step S102, it is confirmed whether or not the computer can be assigned to one forward position in the Y direction (S103, S105, S106). If it is possible to assign the computer to this position, the next computer is assigned to the coordinates of this position (S108).

Since the routers are arranged in a 4×4 grid in the computer system illustrated in FIG. 1, the value of N in remainder operation in Steps S104 and S105 is 4. Further, in the case where another computer is already assigned to the coordinates in Step S106, a configuration direction of the virtual ring is shifted by assigning the computer to one backward position in the Y direction (S107). For example, in FIG. 1, a processing of Step S107 is performed in assigning the computer N9.

Since a band of the virtual ring is shifted by two stages every time the grid network is gone around according to the method described above, all coordinates can be filled up as in one stroke drawing when vertical and horizontal sizes of the grid network are both even numbers.

Since the routers are connected by the network switches in the computer system illustrated in FIG. 1, there are computers which are adjacent network-wise although they are not physically adjacent. For example, the computers adjacent to the computer N1 network-wise are nodes N2, N13 and N14 capable of communication via the network switch SW-X1 and the nodes N16, N9 and N8 capable of communication via the network switch SW-Y1.

Although the computers adjacent on the virtual ring are invariably physically adjacent in the virtual ring configuration method illustrated in FIG. 3, there are other configuration methods equivalent in terms of network topology due to the aforementioned property. Specifically, even if an arbitrary row in an X-axis direction is replaced in the network configuration illustrated in FIG. 1, a resulting configuration is equivalent in terms of network topology. For example, a network in which the computers configuring a row with a node coordinate Y=0 (N1, N2, N13, N14) and the computers configuring a row with a node coordinate Y=1 (N16, N3, N4, N15) are replaced by each other has a network topology equivalent to the original network. Similarly, rows in a Y-axis direction may be replaced or a row replacement in the X-axis direction and a row replacement in the Y-axis direction may be successively made a plurality of times.

One computer can be arranged under each router by the aforementioned procedure. The computers arranged in this way are referred to as representative nodes below.

In the case where data to be stored in the distributed database are increased, it may exceed a processing power of one DB computer. In such a case, a DB computer needs to be added. At this time, insertion into the virtual ring complies with rules of consistent hashing. It is problematic at which position of the physical network the DB computer is to be added. The computer may be added to satisfy the aforementioned features 1 to 3 as much as possible. A method for adding a new computer as a non-representative node to a configuration in which representative nodes are arranged is described below.

It is difficult to satisfy all the features 1 to 3 at the time of adding a DB computer, but it is possible to satisfy the features 1 and 3. Thus, the position where the computer is to be added is determined in accordance with the following rules.

Rule A1: The new computer is connected at a position adjacent on the physical network to two representative nodes adjacent to the new computer to be added on the virtual ring, i.e. a router connected to an inter-router network segment commonly used by the above two computers.
Rule A2: Three computers adjacent on the virtual ring are connected to different routers.
The feature 1 can be satisfied by the rule A1 and the feature 3 can be satisfied by the rule A2.

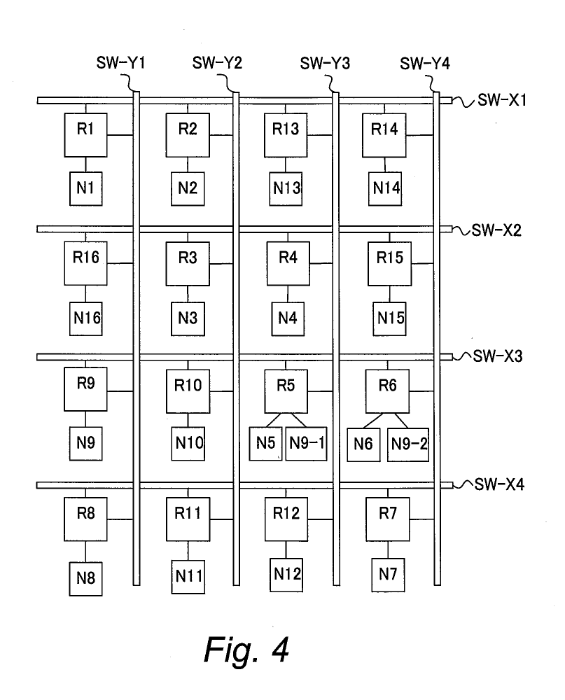

For example, FIG. 4 illustrates an example in which computers N9-1 and N9-2 are added between the computers N9 and N10 on the virtual ring, the computer N9-1 is connected to the router R5 and the computer N9-2 is connected to the router R6. The representative nodes adjacent to these computers N9-1, N9-2 are the computers N9, N10 and the inter-router network segment commonly used by these uses the network switch SW-X3. Accordingly, to satisfy the rule A1, the new computer only has to be added under the router connected to the network switch SW-X3. Further, to satisfy the rule A2, the computers N9-1 and N9-2 are connected to different routers.

On the other hand, in the case where new computer(s) is/are added by the aforementioned connection method, a load may be possibly concentrated on a specific network. For example, in the computer system illustrated in FIG. 4, a load of the network switch SW-X3 increases. In view of this, a method is conceivable in which the restriction of the rule A1 on network distances is eased and a new computer is added in accordance with:

Rule A1b: The new computer to be added is connected at a position adjacent on the physical network to either one of two representative nodes adjacent to the new computer on the virtual ring.

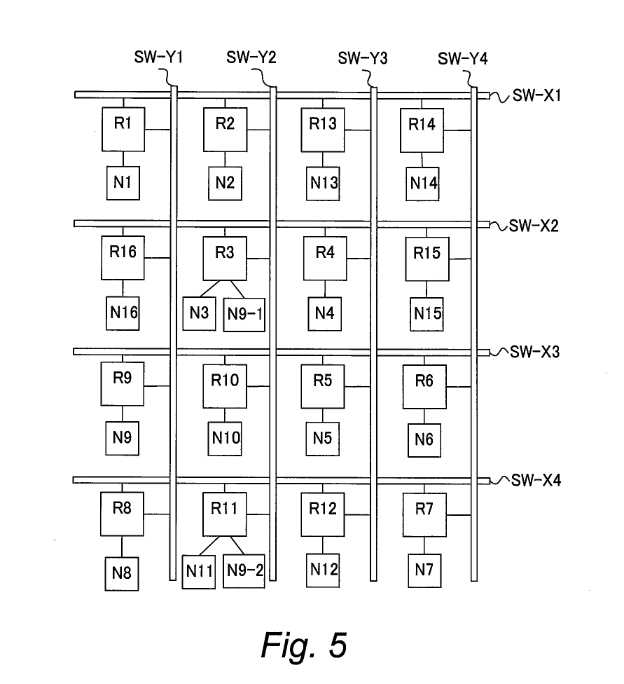

For example, in a computer system illustrated in FIG. 5, a new computer N9-1 is connected to the router R3 connected to the network switch SW-Y2 to which the router R10 is directly connected and a computer N9-2 is connected to the router R11 connected to the network switch SW-Y2. In the case where the new computers are connected in this way, a load on the network switch SW-X3 can be reduced. Communication is possible without via any router between the computers N10 and N9-1 and between the computers N10 and the N9-2. However, since a transfer by the router R10 is made halfway in communication between the computers N9 and N9-1 and between the computers N9 and N9-2, a load of the router R10 increases. Therefore, this connection method is effective when the load of the network switch SW-X3 is high and the load of the router R10 has some room.

Similarly, a method for connecting a new computer to the router connected to the network switch SW-Y1 is effective when the load of the network switch SW-X3 is high and a load of the router R9 has some room. The above description can be summarized as follows. Specifically, a state where one DB computer (representative node) is arranged for each router configuring the grid network in accordance with the procedure illustrated in FIG. 3 is assumed as an initial state. In the case of arranging the second and subsequent DB computers for one router, the new computer is added at a position where the aforementioned rules A1, A2 are satisfied when there is room for load or at a position where the rules A1b, A2 are satisfied when the load is high in view of loads of the network switches and the routers.

To implement the aforementioned method, the position where the new computer is to be added needs to be determined based on a network load monitoring result. If this is manually done, it takes time and effort. Accordingly, a configuration management tool for supporting the aforementioned operation is described below.

In the present embodiment, the routers R1 to R16 monitor the amount of data transferred by these routers and transmit the obtained data transfer amount to the master computer M0. The master computer M0 calculates loads of the network switches SW-X1 to SW-X4, SW-Y1 to SW-Y4 and the routers R1 to R16 from the received data transfer amount and determines a position, where a new computer is to be added, based on the calculated loads.

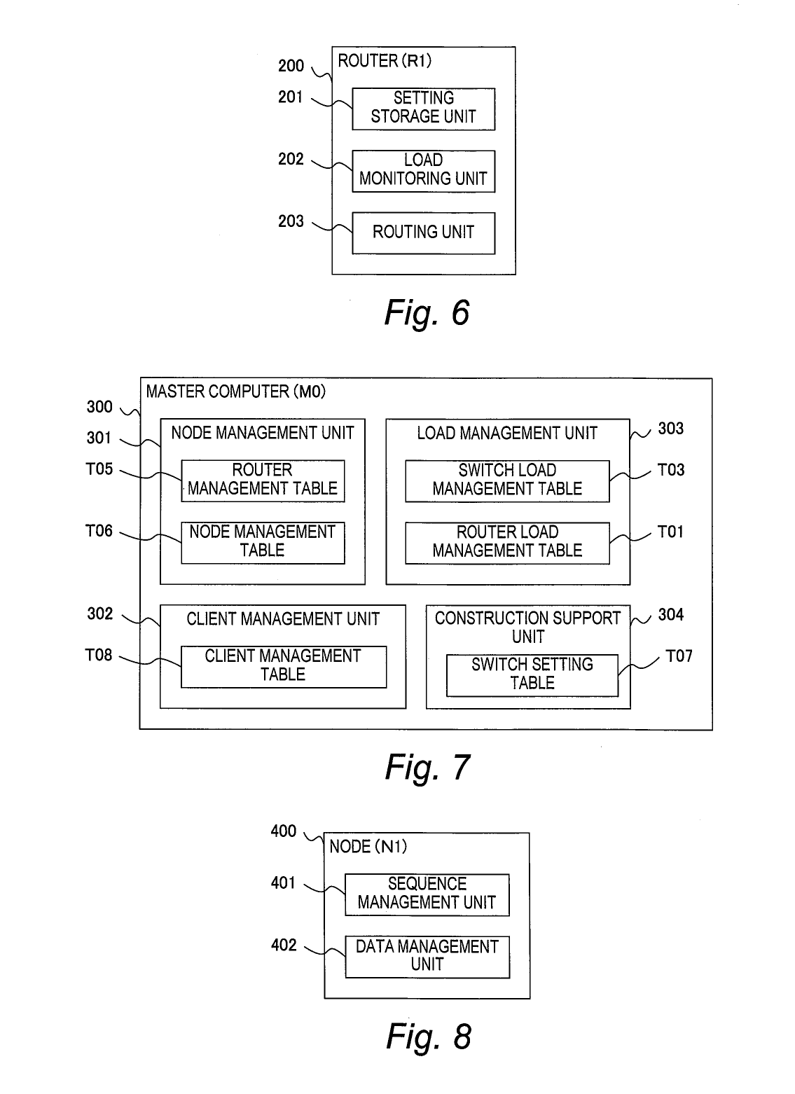

FIG. 6 illustrates a software configuration of the routers R1 to R16 for implementing this and FIG. 7 illustrates a software configuration of the master computer M0.

As illustrated in FIG. 6, the router R1 to R16 includes a setting storage unit 201 for storing various settings of the router, a load monitoring unit 202 for monitoring network loads and CPU loads, and a routing unit 203 for transferring packets flowing in the network. Further, as illustrated in FIG. 7, the master computer M0 includes a node management unit 301 for managing the routers and the DB computers configuring the grid network, a client management unit 302 for managing the client computers C1 to Cn, a load management unit 303 for managing network loads and router loads of the grid network and a construction support unit 304 for determining a position where a new computer is to be added.

The setting storage unit 201 of the router holds a correspondence relationship between network information such as an address of the router, a network address and a broadcast address and the LAN port and the network segment provided in the router for each network segment. Further, the setting storage unit 201 holds a routing table. The routing unit 203 performs a packet transfer process based on this routing table.

The load monitoring unit 202 of the router counts the total numbers of input and output packets having passed each port and tabulates the count values at regular time intervals (e.g. 1 second) for each network segment. Further, the load management unit 202 monitors a CPU utilization ratio of the router and tabulates the monitored value at regular time intervals. The tabulated packet count values and CPU utilization ratio are transmitted to the master computer M0. For example, when the LAN ports 1, 2 are used as the computer network segments, the total values of counters for input packets and output packets of the LAN ports 1, 2 and a correspondence relationship between the router addresses of the computer network segments and the total values of the counter values are sent to the master computer M0. For two types of inter-router network segments, router addresses and the total values of the counter values are similarly transmitted to the master computer M0. It should be noted that the LAN ports and the router addresses for which the totals of the counter values should be calculated are determined from the information held in the setting storage unit 201 in the aforementioned process. When the totals of the counter values are transmitted, the CPU utilization ratio is sent together to the master computer M0.

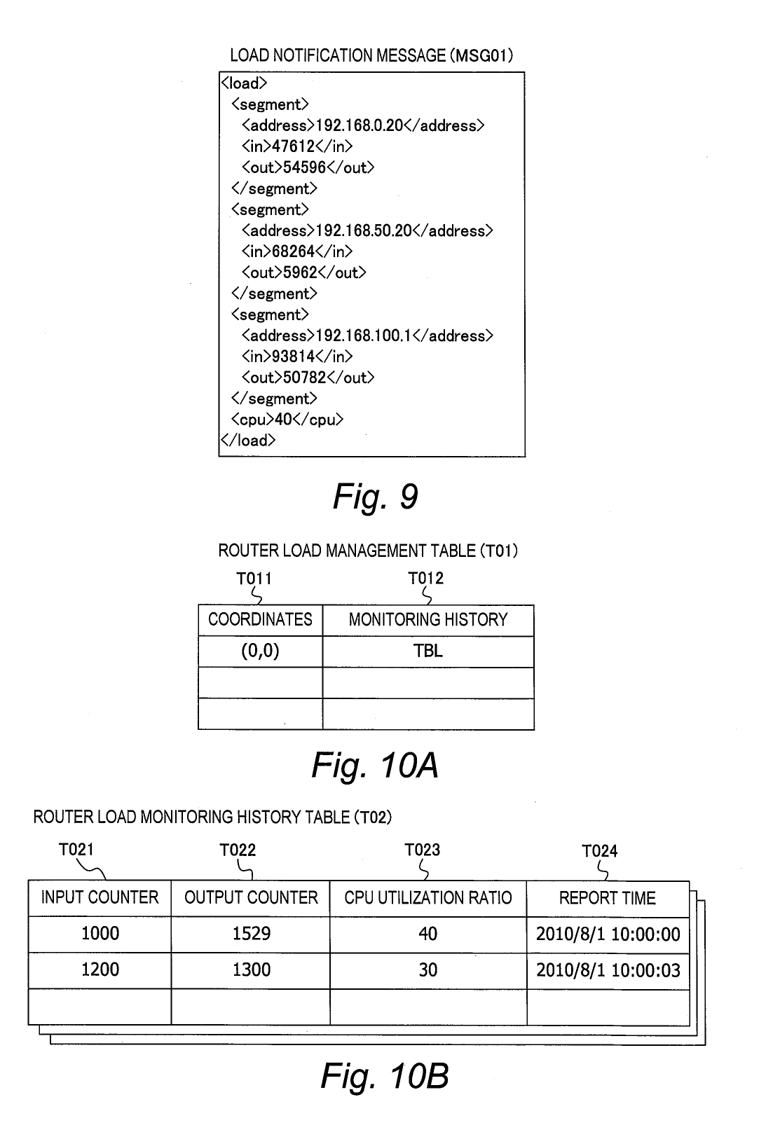

FIG. 9 illustrates an example of a load notification message MSG01 sent to the master computer M0 by the router. The load notification message MSG01 includes the router address, the totals of the input and output counter values and the CPU utilization ratio for each network segment. It should be noted that although the load notification message MSG01 is illustrated in an XML data format in FIG. 9 to facilitate description, another data format may be adopted if information of the same content can be transmitted.

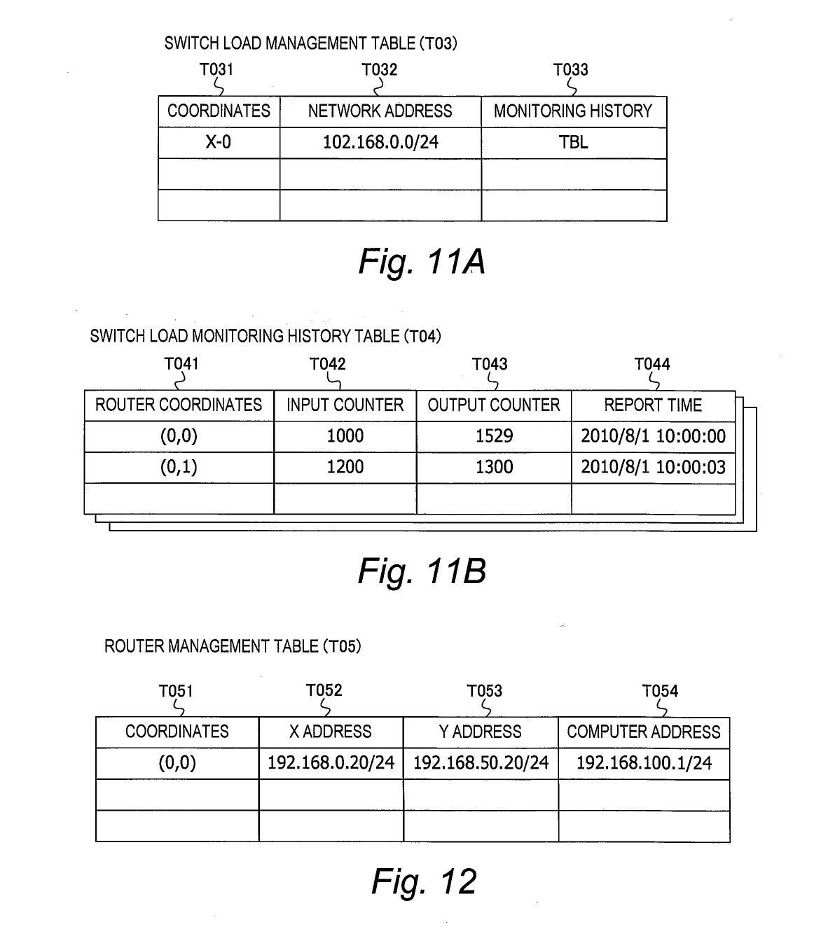

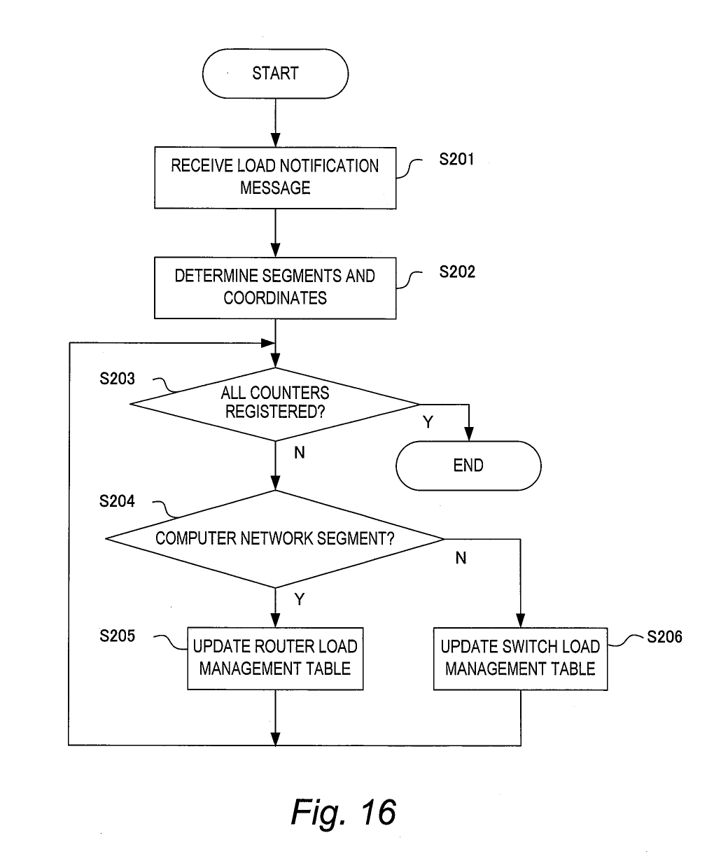

The load management unit 303 of the master computer M0 holds a router load management table T01 (see FIG. 10A) for managing loads of the routers and a switch load management table T03 (see FIG. 11A) for managing loads of the switches. The master computer M0 updates the router load management table T01 and the switch load management table T03 based on the load notification message MSG01 received from the router. An updating process of the router load management table T01 is described using FIG. 16.

When receiving the load notification message MSG01 from the router (S201), the master computer M0 transmits the router address included in the load notification message MSG01 to the node management unit 301 and queries about the type and coordinates of the network segment of each router address.

The node management unit 301 holds a router management table T05 (FIG. 12) and specifies the coordinates and the types of the network segments of the corresponding router using this table. The router management table T05 includes coordinates T051, X addresses T052, Y addresses T053 and computer addresses T054.

The coordinates T051 indicate the position of the router on the grid network. The X address T052 is the router address of the inter-router network segment in the X direction. The Y address T053 is the router address of the inter-router network segment in the Y direction. The computer address T054 is the router address of the network segment for connecting the DB computer. The X address T052, the Y address T053 and the computer address T054 are expressed by a pair of the router address and a network address length as in “192.168.0.20/24”.

Since the router management table T05 is created when the coordinates of the routers R1 to R16 are determined at the time of constructing the system, entries corresponding to the routers R1 to R16 are already registered when the above query from the master computer M0 to the node management unit 301 is received.

When receiving the query from the load management unit 303, the node management unit 301 searches an entry including an address matching the received router address in any of the X address T052, the Y address T053 and the computer address T054 of the router management table T05. The entry found by this search indicates the router having transmitted the load notification message MSG01 and the coordinates T051 of this entry are the coordinates of this router. Further, since the address matching the router address is included in any of the X addresses T052, the Y addresses T053 and the computer address T054, the field name (X address, Y address, computer address) of the matching field is the type of the network segment.

The node management unit 301 sends the coordinates of the routers and the types of the network segments to the load management unit 303 (S202) when obtaining the types of the network segments for all the router addresses for which the load notification message MSG01 was received.

When receiving the network address, the segment information and the coordinates of the router from the node management unit 301, the load management unit 303 registers each address and counter value included in the load notification message MSG01 in the router load management table T01 (FIG. 10A) and the switch load management table T03 (FIG. 11A) (S203). The node management unit 301 retrieves one router address from the load notification message MSG01. In the case where the type of the network segment corresponding to the retrieved router address is a computer network segment, a transition is made to Step S205 to update the router load management table T01. On the other hand, unless the type of the network segment corresponding to the retrieved router address is a computer network segment, a transition is made to Step S206 to update the switch load management table T03 (S204).

The router load management table T01 includes coordinates T011 representing the coordinates of the routers and monitoring histories T012. One entry of this table corresponds to one router. The coordinates of the router such as “(0, 0)” are written in the coordinates T011. An identifier indicating a router load monitoring history table T02 (FIG. 10B) is written in the monitoring history T012. That is, the router load management table T01 has a nest structure including the router load monitoring history table T02 therein.

The router load monitoring history table T02 includes input counter T021, output counter T022, CPU utilization ratio T023 and report time T024.

The input counter T021 is an input counter value received from the router. The output counter T022 is an output counter value received from the router. The CPU utilization ratio T023 is a CPU utilization ratio received from the router. The report time T024 is a time at which the load notification message MSG01 was received from the router. This table is a latest history of load information received from the router and a new entry is added every time the load notification message MSG01 is received. Further, the entry, from the report time of which a certain time (e.g. 24 hours) has elapsed up to the present time, is deleted. The load management unit 303 calculates the amount of input/output data of the computer network segment and the CPU load of the router using this router load monitoring history table T02.

The switch load management table T03 includes coordinates T031 representing the coordinates of the network switches, network addresses T032 and monitoring histories T033. One entry of this table corresponds to one network switch. A direction of an axis on which the network switch is arranged and a coordinate in a direction perpendicular to this shaft such as “X-0” is designated in the coordinate T031. For example, since the SW-X1 is the network switch in the X direction and the coordinate on the Y axis is 0, the coordinate T031 is “X-0”. The network address and the address length such as “102.168.0.0/24” are written in the network address T032. An identifier of a switch load monitoring history table T04 (FIG. 11B) is written in the monitoring history T033. That is, the switch load management table T03 has a nest structure including the switch load monitoring history table T04 therein.

The switch load monitoring history table T04 includes router coordinates T041, input counters T042, output counters T043 and report times T044. The router coordinates T041 are coordinates at which this router is arranged. The input counter T041 is an input counter value received from the router. The output counter T042 is an output counter value received from the router. The report time T044 is a time at which the load notification message MSG01 was received from the router. This switch load monitoring history table T04 is a latest history of load information received from the router and, similarly to the router load monitoring history table T02, a new entry is added every time the load notification message MSG01 is received. Further, the entry, from the report time of which a certain time (e.g. 24 hours) has elapsed up to the present time, is deleted. The load management unit 303 calculates the amounts of data input to and output from the switch using this switch load monitoring history table T04.

If the network segment is a computer network segment as a result of determination in Step S204, the node management unit 301 adds the received counter values in the router load management table T01 and the router load monitoring history table T02. Specifically, the node management unit 301 searches the coordinates T011 of the router load management table T01 using the coordinates determined in Step S202 as a key. If any entry with the matching coordinate T011 is found, the monitoring history T012 of that entry is obtained. The identifier of the router load monitoring history table T02 is registered in the monitoring history T012, one new entry is created in the table indicated by this identifier and values corresponding to the router address written in the load notification message MSG01 received from the router are registered in the input counter T021 and the output counter T022 of the newly created entry. Further, the CPU utilization ratio written in the load notification message MSG01 is registered in the CPU utilization ratio T023 of the newly created entry. Furthermore, the time at which the load notification message MSG01 was received is registered in the report time T024 of the newly created entry (S205).

If the network segment is an inter-router network segment as a result of determination in Step S204, the node management unit 301 adds the received counter values in the switch load management table T03 and the switch load monitoring history table T04. Specifically, the node management unit 301 determines the coordinates of the network switch based on the type of the network segment and the router coordinates determined in Step S202. The coordinates are expressed by a combination of the name (X/Y) of a network segment axial direction and a component of the router coordinates perpendicular to the axial direction. For example, if the network segment determined in Step S202 is a network segment in the X direction and the coordinates of the router are (1, 0), the coordinate of the network switch is “X-0” since the Y coordinate of the router is 0.

Subsequently, the node management unit 301 searches the coordinates T031 of the switch load management table T03 using the determined coordinate of the network switch as a key. If any entry with the matching coordinate T031 is found, the monitoring history T032 of that entry is obtained. The identifier of the switch load monitoring history table T04 is registered in the monitoring history T032, one new entry is created in the table indicated by this identifier and the router coordinates are registered in the router coordinates T041 of the newly created entry. Further, values corresponding to the router address written in the load notification message MSG01 received from the router are registered in the input counter T042 and the output counter T043 of the newly created entry. Further, the time at which the load notification message MSG01 was received is registered in the report time T044 of the newly created entry (S206).

The node management unit 301 performs the processings of Steps S202 to S206 described above for all the router addresses. In this way, the load information of the routers and the network switches is recorded in real time in the master computer M0.

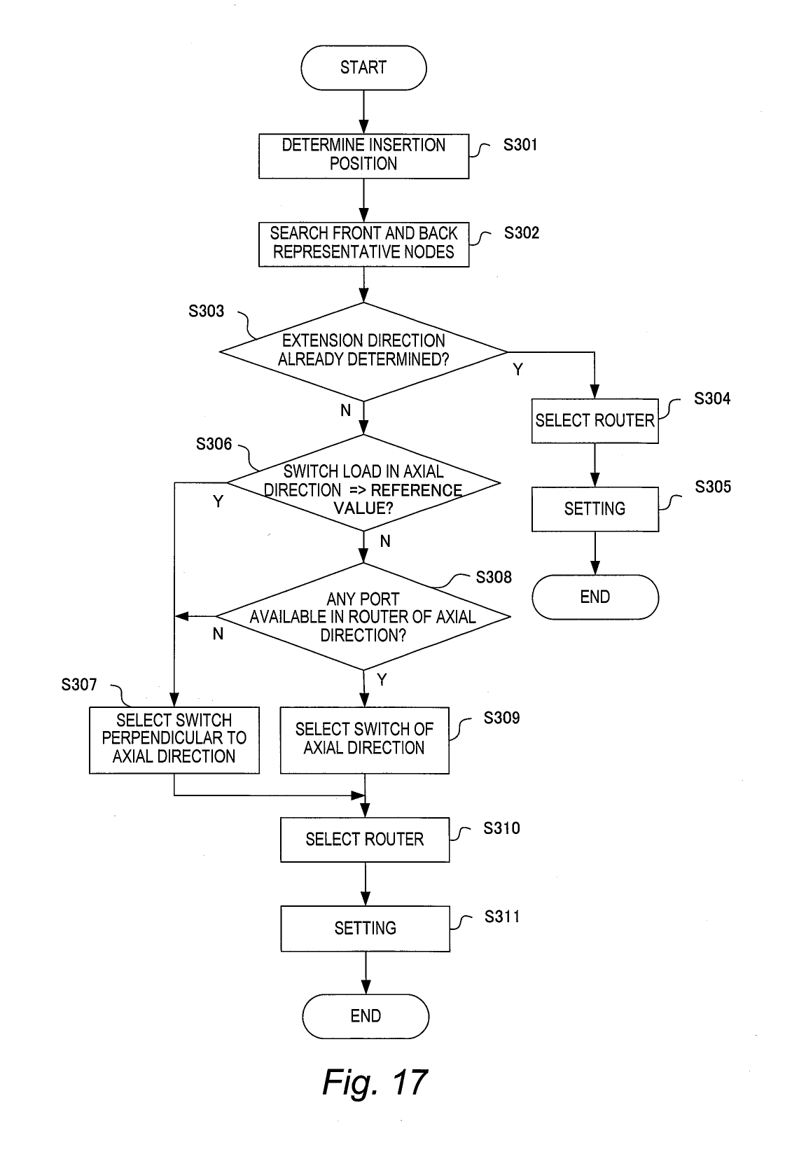

Next, a procedure of determining a position where a new computer is to be added and generating setting information for the new computer at the time of adding the new computer is described using FIG. 17.

When a system administrator activates the configuration management tool on the master computer M0, the construction support unit 304 refers to the node management table T06 and displays the hash values and disk usage rates of all the DB computers configuring the distributed database so that a position where the new computer should be inserted can be determined by the system administrator.

The node management table T06 is a table for managing the DB computers and includes coordinates T061, addresses T062, hash values T063, representative nodes T064, extension switches T065 and disk usage rates T066 as illustrated in FIG. 13. The coordinates T061 are coordinates of the router to which that computer is connected. The address T062 is an address of that computer. The hash value T063 is a hash value of that computer. The representative node T064 is a flag indicating whether or not that computer is a representative node. In the case of a representative node, “true” is stored. The extension switch T065 is the coordinate of the network switch connecting the routers, between which a non-representative node is to be added. The disk usage rate T066 is a usage rate of a disk provided in each node.

The construction support unit 304 displays a list of computers sorted by the hash value or disk usage rate according to needs. Sorting by the hash value enables the configuration of the virtual ring to be displayed in an easy-to-understand manner. Further, sorting by the disk usage rate enables the position of the computer having a high disk usage rate, i.e. a computer for which a computer is to be newly added, to be easily found.

The system administrator determines the position, where the new computer should be added, based on the displayed list of the DB computers and determines a hash value to be assigned to the new computer. The construction support unit 304 receives the input of the position where the new computer should be added and the hash value determined by the administrator.

It should be noted that the hash value may be automatically determined to divide data held by the computer having a highest disk usage rate. In this case, a hash value between the hash value of the computer having a highest disk usage rate and that of the computer located next to the former computer on the virtual ring can be set as a hash value of the new computer (S301).

Subsequently, the construction support unit 304 searches the representative nodes adjacent to a node having the hash value determined in Step S301 from the node management table T06. Specifically, the entries of the node management table T06 are sorted by the hash value T063, and the hash values of the representative nodes (entries with “true” in the representative node T064) are successively confirmed. The entry having a maximum hash value out of the entries having the hash value T063 smaller than the hash value determined in Step S301 and the entry having a minimum hash value out of the entries having the hash value T063 larger than the hash value determined in Step S301 are two adjacent representative nodes.

Out of the two representative nodes, the one having a smaller hash value serves as the front representative node. In the case where such entries do not exist, the entry having a minimum hash value and the one having a maximum hash value out of all the representative nodes serve as two adjacent representative nodes. In this case, the node having a larger hash value serves as a front representative node (S302).

Subsequently, the construction support unit 304 reads the extension switch T065 from the entry of the node management table T06 of the representative node located on the front side out of the two representative nodes obtained in Step S302. In the case where a non-representative node is already inserted, a transition is made to Step S304 since the value is set in the extension switch T065 and an extension direction of the node is determined. In the case where no value is set in the extension switch T065, a transition is made to Step S306 since the extension direction of the node needs to be determined (S303).

In the case where the extension switch T065 is determined to be set in Step S303, the router to which the non-representative node is to be connected needs to be the router connected to the network switch written in the extension switch T065. The construction support unit 304 confirms the coordinate of the network switch written in the extension switch T065 and a list of the coordinates of the routers connected to that network switch is created. For example, in the case where “X-0” is stored in the extension switch T065, all the coordinates whose Y coordinate is “0”, i.e. four coordinates (0, 0), (0, 1), (0, 2) and (0, 3) are generated. These become candidates for the router to which the new computer is to be connected (connection candidate routers).

In this way, a plurality of routers become candidates. The router to which the new computer is to be connected is determined by the following rules.

Rule B1: The router has an available LAN port.
Rule B2: Three computers consecutive on the virtual ring are not connected to the same router.
Rule B3: The router with a low load is preferentially used.

The construction support unit 304 searches the entries of the node management table T06 having the coordinates T061 of the node management table T06 matching the generated coordinates. The number of the entries found for each pair of coordinates is the number of the computers connected to the router. In the case where this number of the computers and the number of the LAN ports assigned to the computer network by the router match at certain coordinates, the corresponding router has no available port. Thus, the router having these coordinates is excluded from the connection candidate routers. In this way, sorting by the rule B1 is performed.

Subsequently, the construction support unit 304 searches the computers adjacent to a computer having the hash value of the new computer from the node management table T06 by a procedure similar to that in Step S302. Although only the representative nodes are search targets in Step S302, all the computers are search targets here. After the adjacent computers are obtained, entries of the node management table corresponding to the computer before the computer adjacent on the front side and the computer directly after the computer adjacent on the back side are obtained. For example, in the case of inserting a new computer between the computers N9-1 and N9-2 in the configuration illustrated in FIG. 4, entries corresponding to two computers N9, N9-1 on the front side and two computers N9-2, N10 on the back side are obtained.

The construction support unit 304 reads the coordinates T061 of the obtained entries and, in the case where there is any connection candidate router whose coordinates match the read coordinates T061, excludes the router having such coordinates from the connection candidate routers. In this way, sorting by the rule B2 is performed.

Subsequently, the construction support unit 304 obtains loads of the connection candidate routers. Specifically, entries with the coordinates T011 matching the coordinates of the connection candidate routers are obtained with reference to the router load management table T01. The identifier of the router load monitoring history table T02 in which a history of load information of this router is stored is written in the monitoring history T012 of the obtained entry. Accordingly, with reference to the router load monitoring history table T02, differences of the input counter and the output counter are calculated using past and present information and average values of the data transfer amounts within a given time are calculated by dividing the calculated differences by a predetermined elapsed time (e.g. 1 hour). Further, by shortening time intervals of calculating the difference, a momentary value of the data transfer amount at a certain time is obtained. The average values of the data transfer amounts within the given time and maximum values of the momentary values of the data transfer amounts are obtained in this way.

Similarly, an average value and a maximum value of the CPU utilization ratio within a given past time are obtained for the CPU utilization ratio T023 of the router load monitoring history table T02.

In this way, the average and maximum values of the network load and the average and maximum values of the CPU utilization ratio are obtained and a load point is calculated based on the obtained values. There are various methods for calculating a load point. For example, calculation by the linear combination of the aforementioned four values using the following equation is conceivable.

Load point=average value of network load×constant 1+maximum value of network load×constant 2+average value of CPU utilization ratio×constant 3+maximum value of CPU utilization ratio×constant 4

The load points of all the connection candidate routers are calculated by the aforementioned procedure and the router having a lowest load point is selected as a connection target. In this way, sorting by the rule B3 is performed (S304).

Subsequently, the construction support unit 304 registers information of the new computer in the node management table T06. Specifically, a new entry is created in the node management table T06, and the coordinates of the connection target router selected in Step S304 are registered as node coordinates in the coordinates T064. The address T062 is not registered at this stage. This is because the node notifies an address (e.g. automatic assignment by DHCP) assigned after the start to the master computer M0 and this notified address is registered. The hash value of the new computer determined in Step S301 is registered in the hash value T063. Since the new computer is not a representative node, no setting is made in the representative node T064 and the extension switch T065.

Further, the construction support unit 304 generates setting information of the new computer. Information to be set is the hash value of the new computer determined in Step S301, the coordinates of the new computer (equal to the coordinates of the router obtained in Step S304) and the address of the new computer. However, concerning the address, in the case where the router operates as a DHCP server for the computer network, all the computers can operate as DHCP clients and it is not necessary to set the addresses of the individual computers. After the construction support unit 304 generates the setting information, the system administrator sets the generated setting information in the new computer and connects the new computer to the router determined in Step S304.

There are various methods for setting the setting information in the new computer. For example, a setting file may be copied from the master computer M0 into the new computer via a memory medium such as a floppy disk or USB memory. Further, the new computer and the master computer M0 may be connected to the same network and the setting information may be copied into the new computer from the master computer M0 via the network by temporarily connecting the new computer to the network switch SW-0 (S305).

In the case where it is determined that the extension switch T065 is not set in Step S303, it is necessary to determine the network segment of the router to which the new computer is to be connected. The construction support unit 304 obtains the coordinates of the two (front and back) representative nodes obtained in Step S302 from the coordinates T061 of the node management table T06 and compares the two pairs of coordinates to confirm a different element (X, Y). The different element serves as an axial direction between the two representative nodes and the identical element serves as a coordinate not including a direction of an axis. For example, in the case of selecting the computers N9, N10 illustrated in FIG. 4 as representative nodes, the coordinates of the computer N9 are (0, 2) and those of the computer N10 are (1, 2). Thus, the axial direction is the X direction, the Y coordinate of the axis is 2 and the coordinate including the direction of the axis is “X-2”.

Subsequently, the load of the network switch corresponding to this axis is obtained. Specifically, entries with the coordinate T031 of the switch load management table T03 matching the obtained coordinate including the direction of the axis are searched. If any entry is found, the monitoring history T032 of that entry is obtained. The identifier of the switch load monitoring history table T04 in which a history of load information of this switch is stored is written in the monitoring history T032 of the obtained entry. Accordingly, with reference to the load monitoring history table T04, differences of the input counter and the output counter are calculated for each pair of the router coordinates T041 for the entries whose report time T044 is within a past given time (e.g. 1 hour). The differences of the counter values are the amounts of data input and output to and from the network switch. Subsequently, average values and maximum values of the differences of the input counter and the output counter are calculated for each pair of router coordinates T041. The sums of the maximum values and the average values obtained for the respective pairs of router coordinates T041 are calculated. For example, in the case where the coordinate of the axis is “X-2”, the maximum value of the differences of the input counter is calculated for each pair of router coordinates (0, 2), (1, 2), (2, 2) and (3, 2) and the sum of the maximum values is calculated. Similarly, the average value of the differences of the input counter is calculated for each pair of router coordinates (0, 2), (1, 2), (2, 2) and (3, 2) and the sum of the average values is calculated. Similarly, the maximum values and the average values of the output counter and the sum of the maximum values and that of the averages are calculated.

By such a procedure, four load parameters (maximum values and average values of input and output data amounts) are calculated for the network switch in the axial direction and it is determined whether or not all the calculated load parameters are not higher than reference values. For example, the reference values may be determined based on the maximum performance of the network switch such as 95% of the maximum performance of the network switch for the maximum value and 70% of the maximum performance of the network switch for the average value. In the case where any of the load parameters is higher than the reference value, a transition is made to Step S307 since the load of the network switch is high. On the other hand, in the case where none of the load parameters is higher than the reference value, a transition is made to Step S308 since the load of the network switch is low (S306).

In the case where the load of the network switch is determined to be low in Step S306, the network switch in the axial direction is selected as the network segment of the router to which the new computer is to be connected. The coordinate including the direction of the axis obtained in Step S306 is registered in the extension switch T065 of the entry of the node management table T06 corresponding to the front representative node out of the two representative nodes obtained in Step S302 (S307).

On the other hand, in the case where the load of the network switch is not lower than the reference value in Step S306, the network switch in the direction perpendicular to the axial direction is selected as the network segment of the router to which the new computer is to be connected. The coordinates of the network switch perpendicular to the axial direction are determined based on the coordinates of the two representative nodes obtained in Step S302 and the axial direction obtained in Step S306. For example, in the case of selecting the computers N9, N10 illustrated in FIG. 4 as the representative nodes, the coordinates of the computer N9 are (0, 2), those of the computer N10 are (1, 2) and the axial direction is the X direction. Accordingly, the direction perpendicular to the axial direction is the Y direction, and the coordinates “Y-0”, “Y-1” of the axis extending in the Y direction from the coordinates of the selected representative nodes are the coordinates of the network switch.

The construction support unit 304 calculates load parameters (maximum values and average values of input and output data amounts) of the two network switches extending in the direction perpendicular to the axial direction in a procedure similar to that in Step S306. Then, a load point is calculated based on the calculated load parameters. There are various methods for calculating a load point. For example, calculation by the linear combination of the squares of the aforementioned four values using the following equation is conceivable.

Load point=constant 1×(average value of input amount)²+constant 2×(maximum value of input amount)²+constant 3×(average value of output amount)²+constant 4×(maximum value of output amount)²

The squares of the load parameters are used in this equation to estimate a higher load when the input and output data amounts approach a performance limit of the network switches. In this way, the load points of the two network switches extending in the direction perpendicular to the axial direction are calculated and the network switch having a lower calculated load point is adopted as a connection segment of the new computer.

The construction support unit 304 registers the coordinate of the adopted network switch in the extension switch T065 of the entry of the node management table T06 corresponding to the front representative node out of the two representative nodes obtained in Step S302 (S309).

After the processing of Step S307 or S309 is finished, the construction support unit 304 selects the router to which the new computer is to be connected in a procedure similar to that in Step S304 (S310). Then, the information of the new computer is registered in the node management table T06 in a procedure similar to that in Step S305 and, subsequently, setting information to be set in the new computer is generated and the generated setting information is set in the new computer (S311).

If the number of the computers configuring the distributed database is increased, problems of insufficient LAN ports of the routers and a higher load on one router occur with a method for adding the computer(s) to one router. In such a case, it is necessary to enlarge the grid size and reconfigure the system. However, the reconfiguration of the system is an operation requiring a lot of time and effort and a construction support by automated setting is desirable. A method for setting automation is described below.

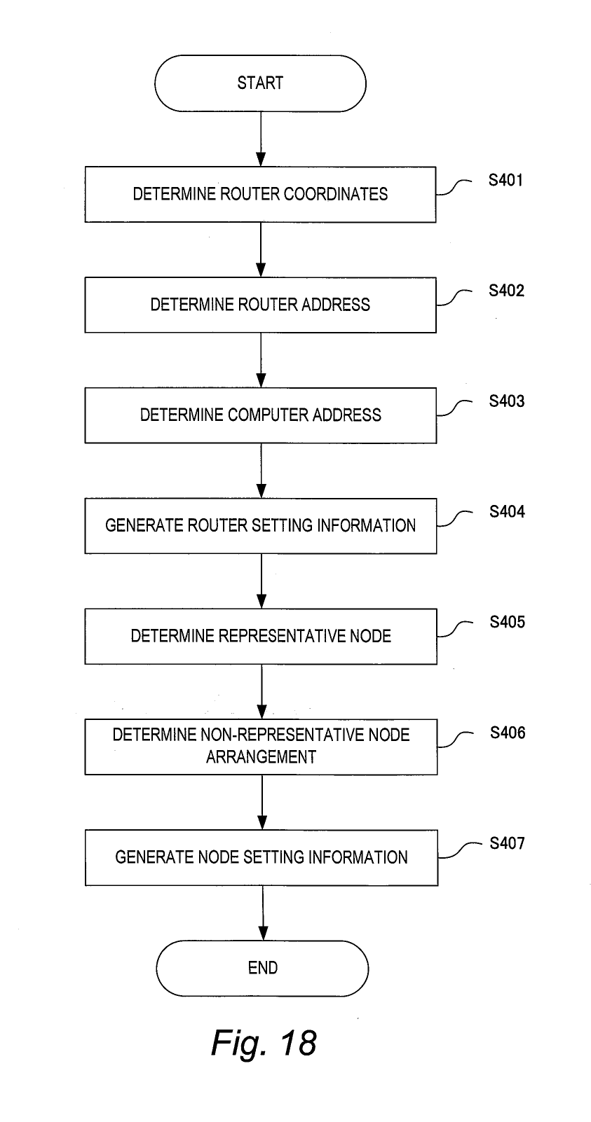

FIG. 18 illustrates the operation of the construction support unit 304 of the master computer M0 in setting automation. An automatic setting processing is described in detail below using FIG. 18.

First, the system administrator inputs the grid size of a new system in the master computer M0. Subsequently, the construction support unit 304 determines coordinates of routers using the procedure described in FIG. 3 after clearing the router management table T05. Although the coordinates of the nodes are determined in FIG. 3, the procedure can be applied to the routers by reading the routers instead of the nodes. Every time the coordinates of the router are determined, a new entry is added to the bottom of the router management table T05 and the determined coordinates are registered in the coordinates T051 of that entry. When the assignment of the routers to all grid points is finished in this way, the entries corresponding to the routers are arranged in a sequence on a virtual ring on the router management table T05 (S401).

The construction support unit 304 generates an address list of network switches from the grid size input by the system administrator in Step S401 and registers the generated address list in coordinates T071 of a switch setting table T07 (FIG. 14). In the switch setting table T07, each entry corresponds to one network switch and the coordinates T01 and network addresses T072 are included. The coordinate T071 is the coordinate of the network switch. The network address T072 is a network address of a network segment taken in charge by this network switch. The network address is expressed as a combination of a network address “192.168.0.0” and an address length “24” as in “192.168.0.0/24”.

The construction support unit 304 prompts the system administrator to determine the address of the network segment of the each network switch configuring the grid network. At this time, it is easy to understand if the construction support unit 304 displays a network diagram as illustrated in FIG. 4 on the display and illustrates the position of each network switch on the network. The system administrator inputs a correspondence relationship between the coordinates of the network switches and the network addresses. The construction support unit 304 registers a value input by the system administrator in the network address T072 of the entry with the matching coordinate T071 of the switch setting table T07 (S402).

Subsequently, the construction support unit 304 determines the X address T052, the Y address T053 and the computer address T054 of each entry of the router management table T05. Specifically, for the X address and the Y address, the coordinate of the corresponding network switch is determined based on the elements of the coordinates T051 in the axial direction and a direction other than the axial direction, and the network address is obtained from the determined coordinate of the network switch with reference to the switch setting table T07. Thereafter, addresses not used in the network are successively assigned.

For example, in the case where (0, 1) are stored in the coordinates of the router management table T05, “X-1” as a combination with the Y element is the coordinate of the corresponding network switch since the axial direction is the X direction. Entries with the coordinate of the network switch matching the coordinate T071 of the switch setting table T07 are searched from the switch setting table T07. As a result, “192.168.1.0/24” becomes the corresponding network address. Only the router uses this network segment. Then, the construction support unit 304 assigns an address other than those already assigned to the other routers and stores that address in the X address T052. For the Y address, an address is similarly determined and the determined address is stored in the Y address T053.

The computer addresses T054 are determined after the X addresses and Y addresses of all the routers are determined. The computer addresses T054 only have to be unused network segments since a unique network segment may be set for each router. The construction support unit 304 successively assigns unused network segments to the routers and registers the first addresses of the assigned network segments in the computer addresses T054 (S403).

The construction support unit 304 generates setting information of the routers based on the router management table T05. Specifically, three network segments corresponding to the X address T052, the Y address T053 and the computer address T054 are set, the address of the router corresponding to each network segment is set, the LAN port of the corresponding router is assigned to each network segment and a DHCP server corresponding to the computer network segment is set. One LAN port is assigned for each of the X address and the Y address, and the remaining LAN port is assigned to the computer address. The generated setting information is set in the router by means of a medium such as a floppy disk or the network by the system administrator. In the case of setting by means of the network, each router needs to be temporarily connected to the network segment connected to the master computer M0 (network segment corresponding to the network switch SW-0) (S404).

Subsequently, the construction support unit 304 determines a re-arrangement method of each node. Since a list of the computers configuring the distributed database is written in the node management table T06, the computers, which will become representative nodes, are selected from the computers written in the node management table T06. The construction support unit 304 clears the coordinates T061, the address T062, the representative node T064 and the extension switch T065 for all the entries of the node management table T06. Subsequently, all the entries of the node management table T06 are sorted by the hash value T063. Subsequently, entry numbers of the representative nodes are obtained using the following equation.

Entry Number=integer part of (grid number×total entry number/grid number)

In this equation, the grid number is a number indicating the order of the node on the virtual ring and any one of values from 0 to grid number−1. Further, the entry number is a number indicating the order of the entry of the node management table T06 after sorting, wherein the first entry is 0 and the last entry number is sum of the entry number−1.

After the entry number corresponding to the grid number is obtained, the coordinates T051 of the (grid number)^{th} entry from the beginning out of the entries included in the router management table T05 are obtained. These obtained coordinates are registered in the coordinates T061 of the (entry number)^{th} entry from the beginning out of the entries included in the node management table T06 and “true” is set in the representative node T063 of that entry (S405).

Subsequently, the construction support unit 304 determines the coordinates T061 in a procedure similar to that in FIG. 17 for the entry for which the coordinates T061 of the node management table T06 are not determined. However, since the distributed database does not operate at this time, there is no data to be input to or output from the routers and the network switches. Thus, after Step S306, a transition is invariably made to Steps S308 and S309. Further, in Steps S305 and S311, setting information is generated and set in a new computer. However, since all pieces of setting information are set at once in Step S407 in this automatic setting process, only the registration of the new computer in the node management table T06 is made in Steps S305 and S311 (S406).

Finally, the construction support unit 304 generates setting information of each computer and sets the generated setting information in each computer in a procedure similar to that in Step S305 (S407).

Next, a normal operation is described.

When first accessing the distributed database system, the client computer C1 queries the master computer M0 and obtains the coordinates T061, the addresses T062 and the hash values T063 of the node management table T06 from the master computer M0. Once the information of this node management table T06 is obtained, it needs not be obtained again until the configuration of the DB computers is changed.

The client management unit 302 of the master computer M0 holds the address of the client computer using the system in a client management table T08 (FIG. 15). The client management table T08 includes addresses T081 and cache release dates and times T082. The address T081 is the address of the client computer. The cache release date and time T082 are a time at which the content of the node management table T06 was transmitted to a client. When the configuration of the DB computers is changed, the master computer M0 requests to invalidate caches of the node management table T06 to all the clients registered in the client management table T08. Further, when a given time elapses from the cache release date and time, the master computer M0 determines a loss of the client and deletes the corresponding entry from the client management table T08. Thus, the client computer accesses the master computer M0 at regular time intervals and updates the cache release date and time T082.

When writing data, the client computer C1 refers to the node management table T06 cached by itself and obtains the entry of the computer (primary node) in which the hash value of a key to be accessed is stored. Subsequently, when all the entries are sorted in an increasing order of the hash value, the entries of two computers (backup nodes) located at the first and second positions from the obtained primary node are obtained.

After the entries of the primary node and the backup nodes are obtained, the client computer transmits the data to the computer having an intermediate hash value (i.e. first backup node). According to the computer arrangement method described thus far, three consecutive computers are arranged in an L-shape or linearly. In the case of an L-shaped arrangement, the data can be efficiently transferred if being first transmitted to the middle computer and then transferred to the computers on the opposite ends from the middle computer. Because of this, the client computer first transfers the data to the middle computer having the intermediate hash value.

FIG. 8 illustrates a software configuration of the DB computer.

The DB computer includes a sequence management unit 401 for managing a sequence in which data is to be written and a data management unit 402. In writing data, a sequence number is assigned to a key value to be written by the sequence management unit 401 of the primary node. The backup nodes write a key sequence number assigned by the primary node in relation to the key value. The sequence number increases every time data is written. In writing data in the backup node, that data is not written in the case where a sequence number larger than the one to be written is already written. By such a method, the consistency of data can be guaranteed.

Since the middle node is the backup node, it does not have an authority to commit data even if receiving the data from the client computer. The middle node transfers the data to the master node and requests the sequence number. Further, the middle node transfers the data to the other backup node.

When the master node receives the data, the sequence management unit 401 assigns a sequence number and the data management unit 402 starts writing the data. Then, the master node returns the sequence number to the middle node. The middle node sends the sequence number to the other backup node when receiving the sequence number from the master node.

In each backup node, the sequence number already related to the key value to be written and the sequence number newly received from the primary node are compared and the data is written in the case where the sequence number received from the primary node is larger.

Although the client computers C1 to Cn and the master computer M0 are arranged for the network segment different from those of a computer group including the DB computers in the above embodiment, the functions of the client computers may be possessed by the DB computers N1 to N16. Further, the master computer M0 may be connected to the computer network segments of the routers R1 to R16 or may be connected to the network switches SW-X1 to SW-X4, SW-Y1 to SW-Y4.

When the DB computers N1 to N16 double as the client computers, an access to the DB computer from the client computer by the aforementioned method is not necessarily optimal. For example, in the case where the client computer is the computer N1 and the primary node and the backup nodes are the computers N14, N15 and N16, after data is transferred from the client computer N1 to the computer N15, it is transferred again from the computer N15 to the computers N14 and N16. However, since an access from the client computer N1 to the computer N15 is routed via the router R14 or R16, the number of data transfers increases.

Thus, when the DB computers N1 to N16 double as the client computers, it is efficient that data is written by a procedure of, after data is transferred to the DB computer having a shortest network distance from the client computer, transferring the data from the DB computer having the data first transferred thereto to other DB computers.

Specifically, the client computer refers to the node management table T06 cached by itself and compares the coordinates of its own and coordinates of the primary node and the backup nodes (obtained from the coordinates T061) after the primary node and the backup nodes on which the data is to be written are determined, and the computer having a shortest network distance is obtained in the following order.

1. DB computers having the same coordinates as those of the client computer.
2. DB computers, one element of the coordinates of which is the same as that of the client computer.
3. DB computers, two elements of the coordinates of which are different from those of the client computer.

After the data is transferred to the DB computer having a shortest network distance, the data is transferred from the DB computer having the data first transferred thereto to other DB computers.

Since a grid network capable of using high throughput is used as a physical network in the present invention, use in an application required to have high throughput is effective. Necessary throughput increases as the amount of stored data per key increases. One of applications having such a feature is a file server.

Specifically, in the case where the content of a file is stored as a value corresponding to a key in a distributed database of the present invention, using a file ID (or path name of the file) as the key, the distributed database can be used as a file server. The above file ID is an identifier of the file which is given to the file when the file is created, and never changed. In a normal file server, the above file ID is called an “i-node number”.

To realize a directory function having a hierarchical structure, a file may be stored in a distributed database using the path name of a directory as a key and the file ID of the file in the directory and various pieces of attribute information (file name, time stamp, file size, etc.) as values.

Further, in the case where it is desired to manage the content of the file while dividing it into a plurality of blocks, the file may be stored in the distributed database using the file ID and offset positions of the blocks as keys and the contents of the blocks as values.

The present invention can be variously modified within the scope of the gist. Although the use of the IP protocol for inter-router communication in the grid is supposed in the description made thus far, another protocol may be used depending on routers and switches. For example, if a protocol is used which designates coordinates as an address of a data transmission destination, more efficient implementation is possible.

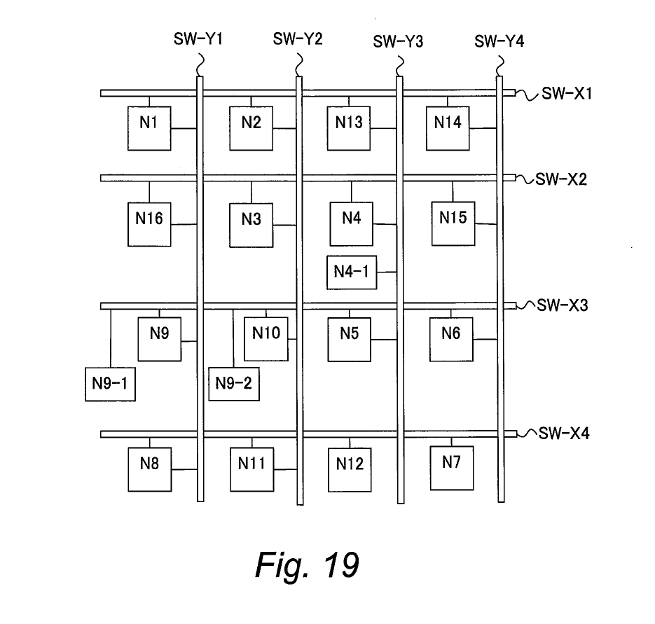

Although the DB computers are connected to the routers arranged on the grid points in the above description, routers may double as DB computers, i.e. the routers and the DB computers may be integrally configured as illustrated in FIG. 19. In this case, the routers serve as representative nodes. Further, in a configuration where DB computers are connected under routers, it is desirable to connect non-representative nodes to switches in the X or Y direction like computers N4-1, N9-1 and N9-2 of FIG. 19 to avoid a network distance between the non-representative nodes from becoming longer.

In the case of such a configuration, the processings of Steps S304 and S310 are not necessary in the procedure for adding the non-representative node (FIG. 17). Further, since no computer network is provided, it is not necessary to store the computer addresses T054 in the router management table T05. The processings other than these are similar to those described above.

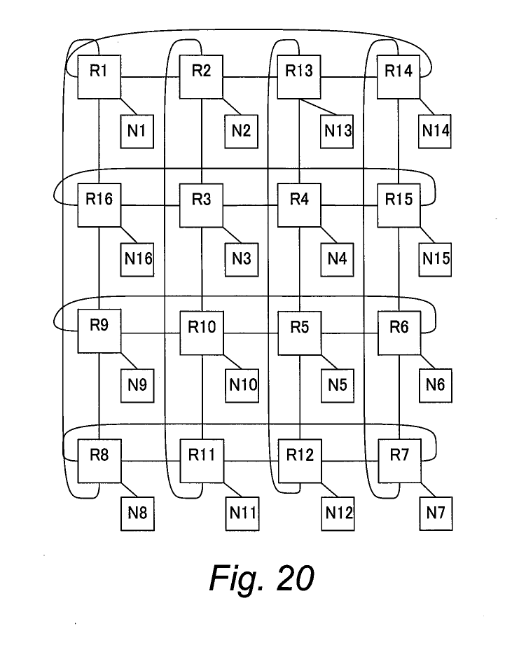

Although the routers arranged on the grid points are connected by the network switches SW-X1 to SW-X4, SW-Y1 to SW-Y4 in the above embodiment, routers may be directly connected to form a two-dimensional torus structure as illustrated in FIG. 20. In the case of connecting the routers by the network switches, the computers having matching X or Y coordinates are adjacent network-wise. However, in the case of a two-dimensional torus structure, only computers whose coordinates are adjacent are adjacent network-wise. It should be noted that a node whose coordinates are (0, 0) and a node whose coordinates are (0, 3) are, for example, adjacent due to the torus structure. In the representative node arrangement method illustrated in FIG. 3, representative nodes adjacent on a virtual ring are adjacent network-wise even if such restriction is provided.

In the above description, the system administrator needs to connect a DB computer to an appropriate router in adding the DB computer. This operation is cumbersome and human errors are likely to occur. Thus, a system is conceivable in which a port to a computer network segment from each router is connected to DB computers via a cross bar switch SW-A as illustrated in FIG. 21.

Instead of connecting the DB computers to the ports of the routers, the routers and the DB computers are connected to the cross bar switch SW-A and connection is changed by controlling the cross bar switch SW-A. Accordingly, the cross bar switch SW-A only has to electrically connect ports connected to the routers and ports connected to the DB computers N1 to N16 and needs not have a function of controlling a transfer destination based on a packet to be transferred unlike the network switches. Thus, the cross bar switch SW-A even including a large number of ports is inexpensive. The switching of the cross bar switch SW-A is controlled via a control line L1 by the master computer M0. The control line L1 may be a serial communication line such as RS-232C or a network such as Ether.

Although one router and the cross bar switch SW-A are connected by one line in FIG. 21 for the convenience of drawing layout, one router and the cross bar switch SW-A may be connected by a plurality of lines. Further, although there are 16 DB computers in FIG. 21, more DB computers may be actually used.

Further, a device in which the routers R1 to R16, the network switches SW-X1 to SW-X4, SW-Y1 to SW-Y4, the cross bar switch SW-A and the master computer M0 illustrated in FIG. 21 are integrated may be mounted and DB computer(s) may be added according to needs. Further, router(s) may be added to the above device according to needs.

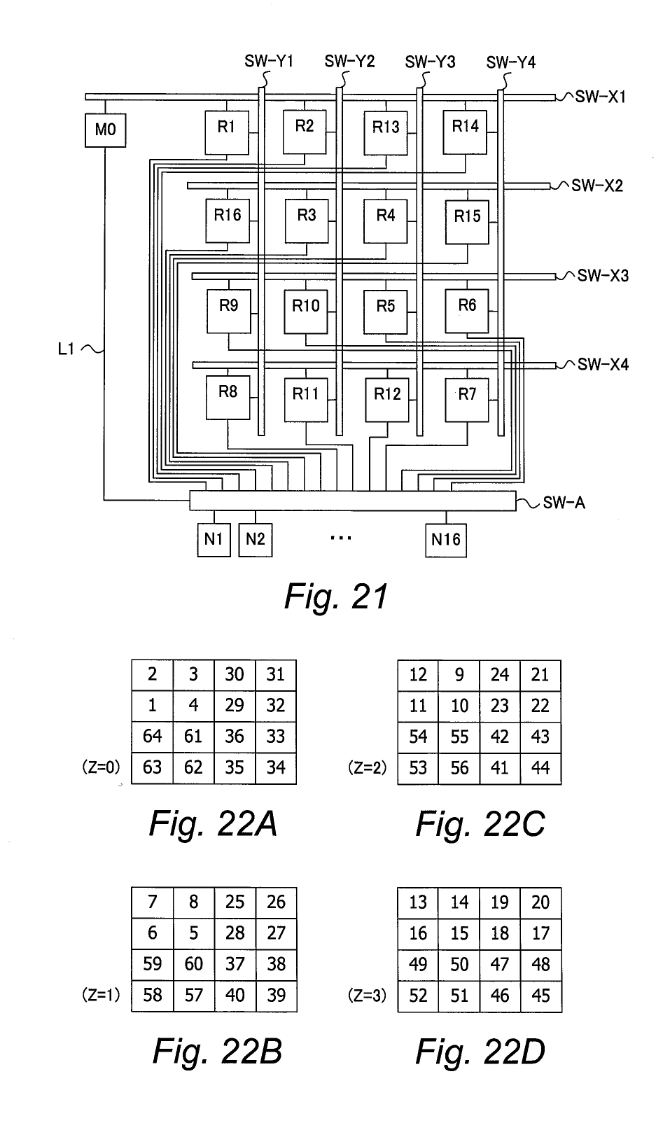

Although the two-dimensional grid is described as an example in the present embodiment, the present invention can also be applied to a grid having a number of dimensions greater than 2. FIGS. 22A to 22D illustrate a sequence of representative nodes on a virtual ring and an arrangement of an X-Y plane at each Z coordinate in the case of configuring a system by a three-dimensional grid. It should be noted that, in the three-dimensional grid, it is difficult to simultaneously satisfy the feature 1 (representative nodes adjacent on the virtual ring are also adjacent network-wise) and the feature 2 (all the network switches are passed the same number of times if the representative nodes are successively followed along the virtual ring). In the arrangement of computers illustrated in FIGS. 22A to 22D, the feature 1 is completely satisfied, but the feature 2 is not satisfied at some locations.

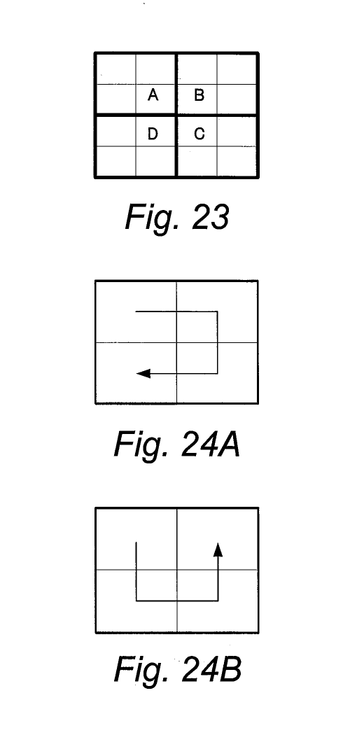

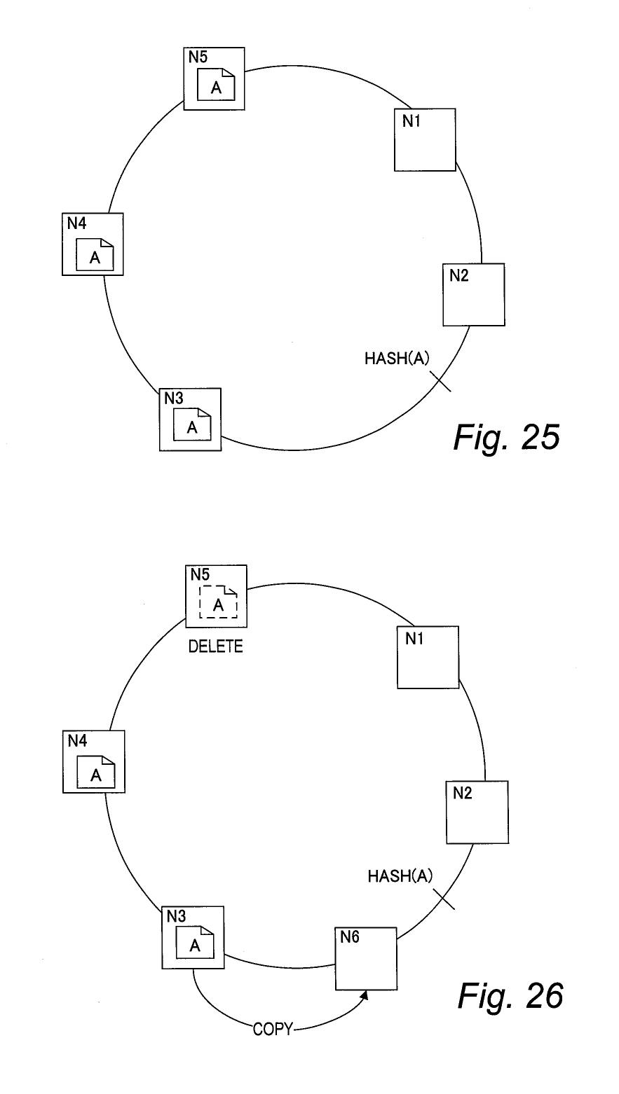

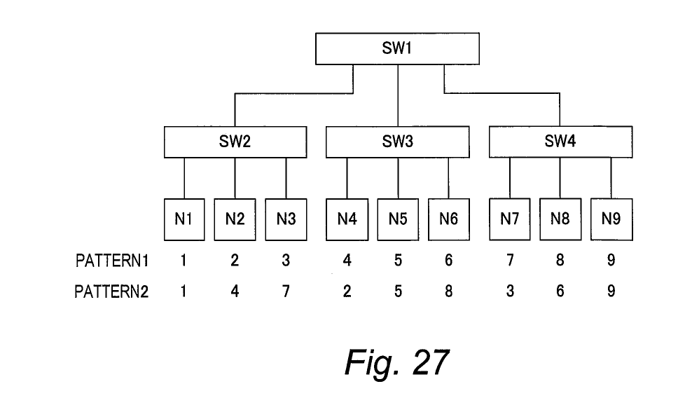

A rule in arranging the computers is described below. Since this problem results in a problem of one stroke drawing in the three-dimensional grid, it is described as one stroke drawing below. First, the X-Y plane is divided into 2×2 areas for all the Z coordinates. Since the system illustrated in FIGS. 22A to 22D is a grid having the size of one side of 4, one X-Y plane is divided into four areas as illustrated in FIG. 23. Such areas are created for four Z coordinates. At this time, boundaries between the areas are set at the same positions on different X-Y planes. For example, vertical and lateral center lines are boundaries in the X-Y planes at all the Z coordinates in FIGS. 22A to 22D. The respective areas are called by names A to D as illustrated in FIG. 23 below when being referred to.

First, starting from the area A of the X-Y plane at Z=0, a movement is made to the area A at the same position on the X-Y plane at Z=1 after all the four blocks in the area A are passed and a sequence (1 to 4) of these blocks is determined. All the blocks in this area A are passed and a sequence (5 to 8) of these blocks is determined. Thereafter, similarly, a movement is made to the area A at the same position on the X-Y plane at Z=2 and the area A at the same position on the X-Y plane at Z=3, and the blocks in these areas A are passed and sequences of these blocks are determined. After the sequence (13 to 16) of all the blocks in the area A on the X-Y plane at Z=3 is determined, a movement is made to the area B adjacent on that X-Y plane, the respective X-Y planes are passed in the order of Z=3, Z=2, Z=1 and Z=0 in the areas B, and a sequence (17 to 32) of the blocks in the areas B is determined. After the area B at Z=0 is passed, a movement is made to the area C adjacent on the X-Y plane at Z=0 and, similarly, the respective X-Y planes are passed in the order of Z=0, Z=1, Z=2 and Z=3 in the areas C. Finally, the respective X-Y planes are passed in the order of Z=3, Z=2, Z=1 and Z=0 in the areas D and a return is made to the start position.

If the area is thought as one grid, the arrangement of the nodes made by the procedure of FIG. 3 can be applied to the arrangement of the areas. This enables the areas different in the X-Y planes to be adjacent in the order of passage (it should be noted that the procedure of FIG. 3 can be applied only when one side of the grid is a multiple of 4, FIG. 23 illustrates a case of a minimum size and the procedure of FIG. 3 is applied). Thus, when a movement is made between different areas at Z=0 and Z=3, it is guaranteed that the area at a movement destination is adjacent. Further, since the positions of the areas on the X-Y planes do not change when the Z coordinate changes, it is guaranteed that a grid point at a movement destination is adjacent.

For a movement within the area, two ways of passage can be thought when the movement is started from the upper left of the area. If the areas move leftward or downward, adjacent grid points can be invariably passed during a movement between the areas if the way of passage illustrated in FIG. 24A is adopted. Similarly, if the areas move rightward or upward, adjacent grid points can be invariably passed during a movement between the areas if the way of passage illustrated in FIG. 24B is adopted.

In the above way, the virtual ring can be so created on the three-dimensional grid that the nodes adjacent on the virtual ring are adjacent network-wise by the aforementioned procedure when the size of one side of the X-Y planes is a multiple of 4.

While the present invention has been described in detail and pictorially in the accompanying drawings, the present invention is not limited to such detail but covers various obvious modifications and equivalent arrangements, which fall within the purview of the appended claims.

What is claimed is:

1. A distributed processing system comprising a two or more dimensional grid network, on which a virtual ring of a consistent hash is created, for coupling a plurality of nodes to which hash values are assigned,
the plurality of nodes including at least a computational resource, and
the nodes arranged at positions adjacent on the virtual ring being arranged at positions capable of communication without via other nodes in the grid network.

2. The distributed processing system according to claim 1, wherein:
the node includes a router coupled to the grid network and a computer with the computational resource;
the router is arranged on a grid point connecting segments of the grid network; and
computers configuring the virtual ring is coupled to router.

3. The distributed processing system according to claim 2, wherein three computers consecutively arranged on the virtual ring hold the same data; and
the three computers are respectively coupled to different ones of the routers.

4. The distributed processing system according to claim 2, wherein, in the case of adding a third computer between a first computer and a second computer on the virtual ring, the third computer is coupled to the router on a network segment to which both of the first and second computers are coupled.

5. The distributed processing system according to claim 2, wherein:
in the case of adding a third computer between a first computer and a second computer on the virtual ring, the third computer is coupled to the router on a network segment to which at least one of the first and second computers is coupled.

6. The distributed processing system according to claim 1, wherein:
the node includes a computer having the computational resource and a data transfer function between different network segments; and
in the case of adding a third computer between a first computer and a second computer on the virtual ring, the third computer is arranged on a network segment to which both of the first and second computers are coupled.

7. The distributed processing system according to claim 1, wherein:
the grid network includes at least a first network segment and a second network segment arranged to intersect with the first network segment;
the plurality of nodes include a first node arranged on the virtual ring, a second node arranged at a position next to the first node on the virtual ring, and a third node arranged at a position next to the second node on the virtual ring; and
the first and second nodes are coupled to the first network segment and the second and third nodes are coupled to the second network segment.

8. The distributed processing system according to claim 1, wherein:
the grid network includes at least a first network segment extending in a direction of a first axis and a second network segment extending in a direction of a second axis intersecting with the first axis;
the plurality of nodes include a first node arranged on the virtual ring, a second node arranged at a position next to the first node on the virtual ring and a third node arranged at a position next to the second node on the virtual ring;
the second node is arranged at a position adjacent to the first node in the direction of the first axis; and
the third node is arranged at a position adjacent to the second node in the direction of the second axis.

9. The distributed processing system according to claim 8, wherein:
the second node is arranged at the position adjacent to the first node in the direction of the first axis; and
in the case where another node is already assigned to a position adjacent to the second position in a certain direction of the second axis, the third node is arranged at a position adjacent to the second node in an opposite direction of the second axis.

10. The distributed processing system according to claim 1, wherein a number of nodes adjacent to each node which are arranged on each axis of the grid network is the same.

11. The distributed processing system according to claim 1, wherein the nodes, only one of coordinate elements of which indicating the position on the grid network does not match, are torus-connected.

12. The distributed processing system according to claim 1, wherein:
a first node, a second node and a third node consecutively arranged on the virtual ring out of the nodes store the same data;
a client computer transmits data to the second node located between the first and third nodes on the virtual ring in the case of writing data in the distributed processing system; and
the second node transmits the data received from the client computer to the first and third nodes.

13. The distributed processing system according to claim 1, wherein:
three nodes consecutively arranged on the virtual ring store the same data;
a client computer transmits data to the node arranged at a closest position from the client computer on the network in the case of writing data in the distributed processing system; and
the node receiving the data to be written transmits the received data to other nodes out of the three nodes.

14. A method of node distribution in a distributed processing system in which a virtual ring of a consistent hash is created on a two or more dimensional grid network and a plurality of nodes, to which hash values are assigned, are arranged on the created virtual ring,
the distributed processing system including a grid network for coupling the plurality of nodes and a computer for determining the distribution of the nodes, and
the plurality of nodes including at least a computational resource,
the method, including steps of:
determining, by the computer, the node to be arranged at a next position on the virtual ring by adding an identifier of the node; and
determining, by the computer, the position of the node to be arranged at the next position so that the determined node is arranged at a position capable of communication without via other nodes in the grid network.

15. The method of node distribution according to claim 14, wherein in the case of adding a third node between a first node and a second node on the virtual ring, the computer determines the position of the third node to couple to a router on a network segment to which both of the first and second nodes are coupled.

16. The method of node distribution according to claim 14, wherein, in the case of adding a third node between a first node and a second node on the virtual ring, the computer determines the position of the third node to couple to a router on a network segment to which at least one of the first and second nodes is coupled.

17. The method of node distribution according to claim 14, wherein:
the node has a data transfer function between different network segments; and
in the case of adding a third node between a first node and a second node on the virtual ring, the computer determines the position of the third node to be arranged on a network segment to which both of the first and second nodes are coupled.

18. The method of node distribution according to claim 14, wherein:
the grid network includes at least a first network segment extending in a direction of a first axis and a second network segment extending in a direction of a second axis intersecting with the first axis;
the plurality of nodes include a first node arranged on the virtual ring, a second node arranged at a position next to the first node on the virtual ring and a third node arranged at a position next to the second node on the virtual ring; and
the computer determines the position of the second node which is arranged at a position adjacent to the first node in the direction of the first axis and the third node which is arranged at a position adjacent to the second node in the direction of the second axis.

19. The method of node distribution according to claim 18, wherein the computer determines the position of each node the second node which is arranged at the position adjacent to the first node in the direction of the first axis and in a case where another node is already assigned at a position adjacent to the second position in a certain direction of the second axis, the third node which is arranged at a position adjacent to the second node in an opposite direction of the second axis.
